(19) United States
(12) Patent Application Publication
(10) Pub. No.: US 2023/0105425 A1
(43) Pub. Date: Apr. 6, 2023

(54) ELECTRONIC DEVICE CAPABLE OF DETERMINING TARGET CUSTOMER SUITABLE FOR TRAVEL PACKAGE

(71) Applicant: AX INC., Seoul (KR)

(72) Inventor: Yeonju OH, Seoul (KR)

(73) Assignee: AX INC., Seoul (KR)

(21) Appl. No.: 17/958,335

(22) Filed: Oct. 1, 2022

(30) Foreign Application Priority Data
Oct. 1, 2021 (KR) 10-2021-0130488

(51) Int. Cl. G06Q 30/02

(52) U.S. Cl. CPC G06Q 30/0202; G06Q 30/0204; G06Q 30/0269

(57) ABSTRACT

Disclosed is an electronic device. The electronic device includes: a memory; and a processor configured to control the electronic device by executing instructions stored in the memory so that the electronic device determines a target customer suitable for selling a travel package, in which the memory stores purchaser information associated with actual purchasers who have purchased travel packages of a plurality of sellers and purchase history information associated with purchase histories of each of the purchasers, and the processor uses the purchaser information to generate virtual customers from a real purchaser, generate a test product for testing whether virtual customers make a purchase, and determine a target customer having high expected sales for the test product among the virtual customers.

### TECHNICAL FIELD

Embodiments of the present disclosure relate to an electronic device capable of determining a target customer suitable for a travel package.

### BACKGROUND

As travel demand increases, various travel packages are being planned and sold. Unlike past travel packages that offer accommodation and air tickets, currently, various types of travel packages are being planned and sold, such as providing tours, experiences, or field trips in specific cities.

As the types of travel packages have become diversified, travel package sellers who sell travel packages not only take a lot of time to plan the travel packages, but also make it difficult to predict sales from sales of the travel packages, and identify attributes of customers suitable for advertising the travel packages. If customer groups expected to prefer specific products can be identified, the sales of the travel package sellers can increase.

Matters described in the above background art are intended to help the understanding of the background of the invention, and may include matters that are not the disclosed related art.

### SUMMARY

The present disclosure provides an electronic device capable of determining a target customer having high expected sales for a test product.

According to an aspect of the present disclosure, an electronic device includes: a memory; and a processor configured to control the electronic device by executing instructions stored in the memory so that the electronic device determines a target customer suitable for selling a travel package, in which the memory stores purchaser information associated with actual purchasers who have purchased travel packages of a plurality of sellers and purchase history information associated with purchase histories of each of the purchasers, and the processor generates virtual customers from a real purchaser using the purchaser information to, generate a test product for testing whether virtual customers make a purchase, and determine a target customer having high expected sales for the test product among the virtual customers.

According to an aspect of the present disclosure, an method for determining target customer suitable for travel package performed by the electronic device comprising: generating virtual customers from a real purchaser by using the purchaser information, the purchaser information associated with actual purchasers who have purchased travel packages of a plurality of sellers and purchase history information associated with purchase histories of each of the purchasers, generating a test product for testing whether virtual customers make a purchase, and determining the target customer having high expected sales for the test product among the virtual customers.

According to embodiments of the present disclosure, a method of operating an electronic device may be implemented in a form of a program stored in a computer-readable non-transitory storage medium.

### BRIEF DESCRIPTION OF THE DRAWINGS

FIG. 1 is a diagram illustrating a target customer recommendation system according to embodiments of the present disclosure.

FIG. 2 is a diagram illustrating a target customer recommendation device according to embodiments of the present disclosure.

FIG. 3 is a diagram conceptually illustrating purchaser information and purchase history information according to embodiments of the present disclosure.

FIG. 4 is a diagram conceptually illustrating seller information according to embodiments of the present disclosure.

FIG. 5 is a diagram illustrating a virtual customer according to embodiments of the present disclosure.

FIG. 6 is a diagram illustrating a test product according to embodiments of the present disclosure.

FIG. 7 is a flowchart illustrating an operation of the target customer recommendation device according to the embodiments of the present disclosure.

FIG. 8 is a diagram illustrating a method of calculating a purchase probability according to embodiments of the present disclosure.

FIG. 9 is a flowchart illustrating an operation of the target customer recommendation device according to the embodiments of the present disclosure.

FIGS. 10 and 11 are diagrams for describing an operation of an advertisement page generation unit according to embodiments of the present disclosure.

### DETAILED DESCRIPTION OF EMBODIMENTS

Hereinafter, preferred embodiments of the present disclosure will be described in detail with reference to the accompanying drawings.

Embodiments of the present disclosure will be provided only in order to further completely describe the present disclosure to those skilled in the art, the following embodiments may be modified into several other forms, and the scope of the present disclosure is not limited to the following embodiments. Rather, these embodiments make the present disclosure thorough and complete, and are provided in order to completely transfer the spirit of the present disclosure.

Terms used in the present specification are used in order to describe a specific embodiment, are not to limit the present disclosure. In addition, in the present specification, a singular form may include plural forms unless explicitly described otherwise.

In the description of the embodiment, when each layer (film), a region, a pattern, or structures are described as being formed “on” or “under” a substrate, each layer (film), a region, a pad, or a pattern, “on” and “under” include both “directly” or “indirectly” formed through another layer. In addition, in principle, standards for the upper or lower of each layer are based on the drawings.

The drawings are only for understanding the spirit of the present disclosure, and should not be construed as limiting the scope of the present disclosure by the drawings. In addition, the relative thickness, length, or relative size in the drawings may be exaggerated for convenience and clarity of description.

Those of ordinary skill in the art may understand that various illustrative blocks, devices, or operations described in connection with the configurations disclosed herein may be implemented as electronic hardware, computer software, or a combination of the two. These blocks, devices, or operations may be implemented or performed using a circuit having an arithmetic processing function, such as a processor. The computer software or program may be stored in a storage medium capable of storing data, such as a memory, and may include machine-readable instructions that may be executed by an arithmetic processing circuit such as a processor. An exemplary storage medium may be coupled to the processor, and the processor may read information from, and write information to, the storage medium. Alternatively, the storage medium may be integral with the processor.

Hereinafter, embodiments of the present disclosure will be described with reference to the accompanying drawings.

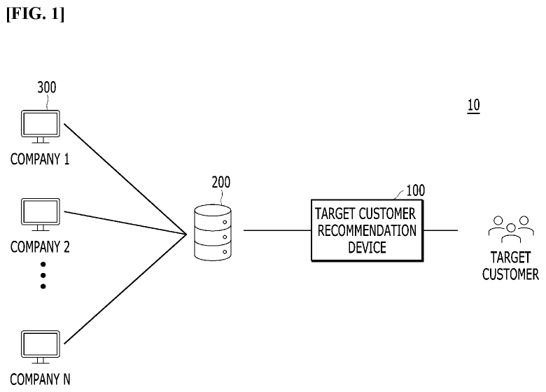

FIG. 1 illustrates a target customer recommendation system according to embodiments of the present disclosure. Referring to FIG. 1, a target customer recommendation system 10 may determine a target customer expected to have the highest expected sales for each of the sellers who sell or provide a travel package.

The target customer recommendation system 10 may include a target customer recommendation device 100, a database 200, and seller terminals 300.

The target customer recommendation device 100 is an electronic device that determines a target customer who is expected to have the highest expected sales using information stored in the database 200. According to embodiments, the target customer recommendation device 100 may use information on travel packages sold by a plurality of sellers, purchaser information of the corresponding travel package, and information related to purchase to determine target customers suitable for each of the sellers. Accordingly, sellers may increase sales through advertisements for the determined target customers.

The database 200 may store information on travel packages on sale provided from the seller terminals 300, purchaser information of the corresponding travel package, information related to purchase, and the like. According to embodiments, the information stored in the database 200 may be read by the target customer recommendation device 100.

The seller terminal 300 may receive and store the information on the travel package on sale, the purchaser information of the corresponding travel package, and the information related to purchase, and transmit the corresponding information to the database 200.

The target customer recommendation device 100 may generate virtual customers and a test product based on the information on the travel package on sale, the information on the purchaser of the travel package, and the information related to purchase, and determine whether virtual customers purchase the generated test product to determine a target customer having high expected sales for the test product among the virtual customers and provide the information on the determined target customer to the seller terminal 300. Accordingly, sellers have the effect of increasing sales by planning advertisements and travel packages using information on target customers.

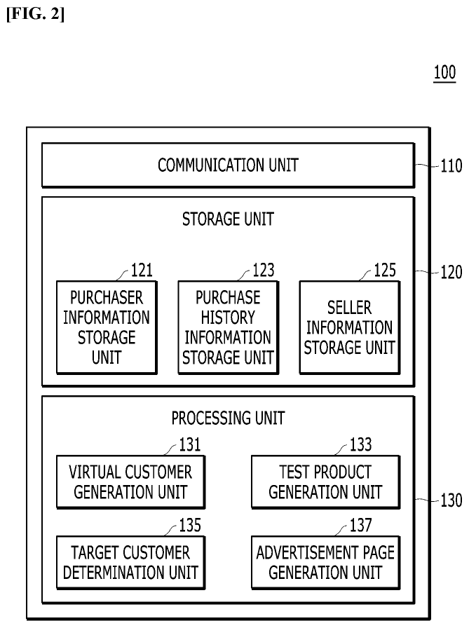

FIG. 2 illustrates a target customer recommendation device according to embodiments of the present disclosure. Referring to FIG. 2, the target customer recommendation device 100 may include a communication unit 110, a storage unit 120, and a processing unit 130.

The communication unit 110 may be configured to exchange data with an external device. According to embodiments, the communication unit 110 may receive data from the database 200 and transmit data to the seller terminal 300.

The communication unit 110 may store the received data in the storage unit 120 under the control of the processing unit 130.

According to embodiments, the communication unit 110 may include at least one of an antenna, a wireless communication circuit coupled to the antenna, and a wired communication circuit having a port connected to an external wired cable, but is not limited thereto.

The storage unit 120 may be configured to store data. According to embodiments, the storage unit 120 may include a non-volatile memory or a volatile memory.

The storage unit 120 may include a purchaser information storage unit 121, a purchase history information storage unit 123, and a seller information storage unit 125.

The purchaser information storage unit 121 may store purchaser information on a purchaser who has actually purchased a travel package of a seller. According to embodiments, the purchaser information may include information on an age, a gender, and residential area of a purchaser.

The purchase history information storage 123 may store purchase history information related to a purchaser's purchase of a travel package. According to embodiments, the purchase history information may include information (e.g., travel area, the number of travelers, travel period, and travel theme) related to a travel package that a purchaser has purchased, and information on a purchase price, a purchase time, and a rating of the travel package.

The seller information storage unit 125 may store seller information on a seller who provides or sells a travel package. According to embodiments, the seller information may include information related to a travel package sold by a seller and information on the number of employees, insurance or not, and whether a vehicle is present.

According to embodiments, the purchaser information, the purchase history information, and the seller information may be collected and stored from the database 200. For example, the target customer recommendation device 100 may process data collected from the database 200 to suit characteristics, generate the purchaser information, the purchase history information, and the seller information, and store each of the purchaser information, purchase history information, and seller information in the purchaser information storage unit 121, the purchase history information storage unit 123, and the seller information storage unit 125.

The processing unit 130 may control the overall operation of the target customer recommendation device 100. According to embodiments, the processing unit 130 may include a processor having an operation processing function, and may perform a specific operation by executing a plurality of instructions.

The processing unit 130 may include a virtual customer generation unit 131, a test product generation unit 133, a target customer determination unit 135, and an advertisement page generation unit 137.

The virtual customer generation unit 131 may generate a plurality of virtual customers and store customer characteristics of the virtual customers. According to embodiments, the virtual customer generation unit 131 may use information stored in the purchaser information storage unit 121 and the purchase history information storage unit 123 to determine customer characteristics of the virtual customers, thereby generating a plurality of virtual customers. That is, a plurality of virtual customers is generated by combining characteristics of purchasers who have previously purchased a travel package, and represents a virtual demand for a specific travel package.

According to embodiments, each virtual customer may have customer characteristics including an age, a gender, and a residential area.

The test product generation unit 133 may generate a test product for testing whether the virtual customer makes a purchase. According to embodiments, the test product generation unit 133 may determine attributes of a test product and generate the test product according to the determined attributes. For example, the attributes of the test product may include a travel area, a travel period, a travel time, the number of travelers, a travel theme, a sale price, and the like.

The test product generation unit 133 may store the test product or the attributes of the test product.

According to embodiments, the test product generation unit 133 may generate the test product based on seller information stored in the seller information storage unit 125. That is, the test product generation unit 133 may generate a test product corresponding to a specific seller. For example, the test product generation unit 133 may generate a test product within the range of a travel package that a specific seller can sell or provide.

According to embodiments, the test product generation unit 133 may generate a test product according to a predetermined product attribute. In this case, the product attributes may be input from the outside and stored in advance.

The target customer determination unit 135 may determine a target customer from among the generated virtual customers. According to embodiments, the target customer determination unit 135 may determine whether the virtual customers generated by the virtual customer generation unit 131 purchases the test product generated by the test product generation unit 133, and determine the target customer who is expected to have the highest expected sales for the corresponding test product according to the determination result. In this case, there may be a plurality of target customers.

The advertisement page generation unit 137 may generate an advertisement page for advertising the test product for the target customer determined by the target customer determination unit. According to embodiments, the advertisement page generation unit 137 may determine an advertisement channel (or advertisement server) and an advertisement phrase suitable for attributes of at least one of a target customer and a test product, and generate an advertisement page including the determined advertisement phrase to suit a format of the determined advertisement channel.

The target customer recommendation device 100 may generate virtual customers and a test product based on the information on the travel package on sale, the information on the purchaser of the travel package, and the information related to purchase, and determine whether virtual customers purchase the generated test product to determine a target customer having high expected sales for the test product among the virtual customers and provide the information on the determined target customer to the seller terminal 300. Accordingly, sellers have the effect of increasing sales by planning advertisements and travel packages using information on target customers.

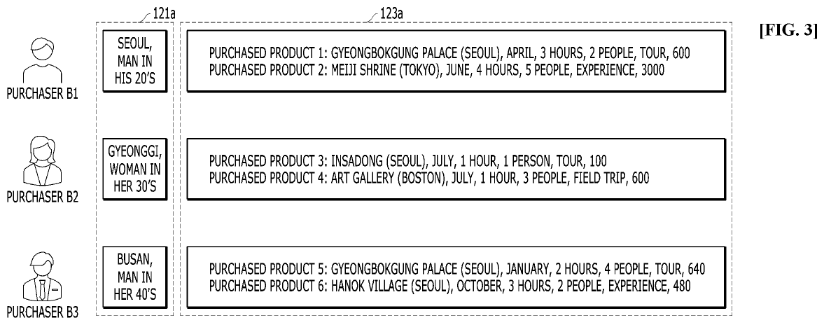

FIG. 3 conceptually illustrates purchaser information and purchase history information according to embodiments of the present disclosure. Referring to FIG. 3, purchaser information 121a may include information on at least one of an age, a gender, and a residential area of a purchaser. Also, purchase history information 123a may include information on at least one of a travel area, a travel period, a travel time, the number of travelers, and a purchase price of a travel package that a purchaser has purchased.

In this case, the purchaser information 121a and the purchase history information 123a may be stored to match each other.

According to embodiments, the purchaser information storage unit 121 may store purchaser information of purchasers B1, B2, and B3. For example, the purchaser information storage unit 121 may store purchaser information for the purchaser B1 indicating “20's” as an age, “man” as a gender, and “Seoul” as a residential area of the purchaser B1.

According to embodiments, the purchase history information storage unit 123 may store purchase history information that includes the information related to the travel package that the purchasers B1, B2, and B3 have purchased and information related to the corresponding purchase. For example, the purchase history information storage unit 123 may store the purchase history information on “Gyeongbokgung palace (Seoul)” as a travel area, “April” as a travel period, “3 hours” as a travel time, “2 people” as the number of travelers, “tour” as a travel theme, and “600” as a purchase price of the travel package that the purchaser B1 has purchased.

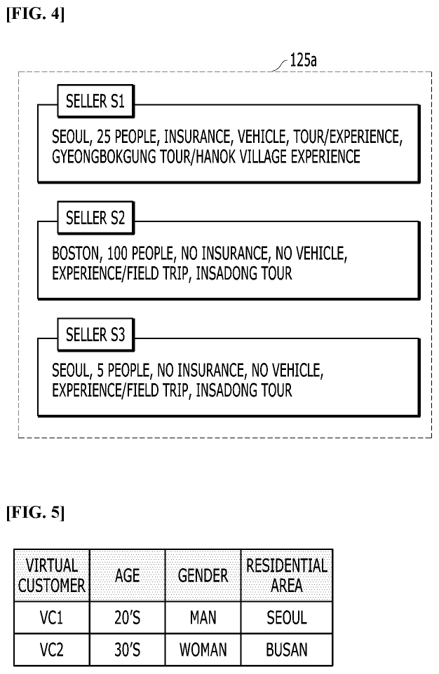

FIG. 4 conceptually illustrates seller information according to embodiments of the present disclosure. Referring to FIG. 4, the seller information 125a may include information on at least one of a main travel destination of a travel package of a seller providing or selling a travel package, the number of employees, insurance or not, presence or absence of a vehicle, a possible travel theme, and an existing sales product.

According to embodiments, the seller information storage unit 125 may store seller information 125a for sellers S1, S2, and S3 selling travel packages. For example, the seller information storage unit 125 may store the seller information indicating “Seoul” as the main travel destination of the seller S1, “25 people” as the number of employees, “insurance” as the insurance or not, “vehicle” as the presence or absence of a vehicle, “tour/experience” as the possible travel theme, and “Gyeongbokgung tour/Hanok village experience” as the existing sales product.

FIG. 5 illustrates a virtual customer according to embodiments of the present disclosure. Referring to FIG. 5, the virtual customer generation unit 131 may determine the attributes of the virtual customer and generate the virtual customer based on the determined attributes. For example, the virtual customer generation unit 131 may generate virtual customers having attributes such as “age,” “gender,” and “residential area.” For example, the virtual customer generation unit 131 may generate a first virtual customer VC1 whose age is “20's,” gender is “man,” and residential area is “Seoul.”

According to embodiments, the virtual customer generation unit 131 may generate virtual customers having arbitrary attributes, or the virtual customer generation unit 131 may determine the attributes of the virtual customer using the purchaser information 121a and the purchase history information 123a to generate the virtual customer.

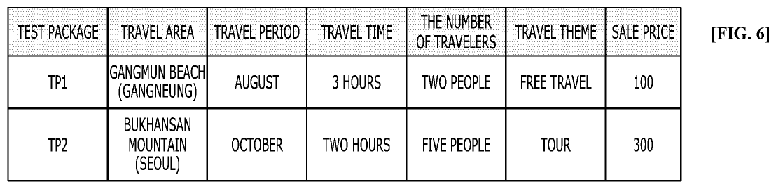

FIG. 6 illustrates a test product according to embodiments of the present disclosure. Referring to FIG. 6, the test product generation unit 133 may generate test products for testing whether the virtual customer makes a purchase.

According to embodiments, the test product generation unit 133 may generate a test product based on the seller information of each of the sellers. That is, since the test product generation unit 133 may design a test product suitable for attributes of a seller, a target customer for the test product has the effect of increasing the sales of the actual seller.

According to embodiments, the test product generation unit 133 may generate test products having attributes such as a travel area, a travel period, a travel time, the number of travelers, a travel theme, and a sales price. For example, the test product generation unit 133 may generate a first test product TP1 whose travel area is “Gangmun Beach,” travel period is “August,” travel time is “3 hours,” the number of travel is “2 people,” and travel theme is “free travel,” and a selling price is “100.”

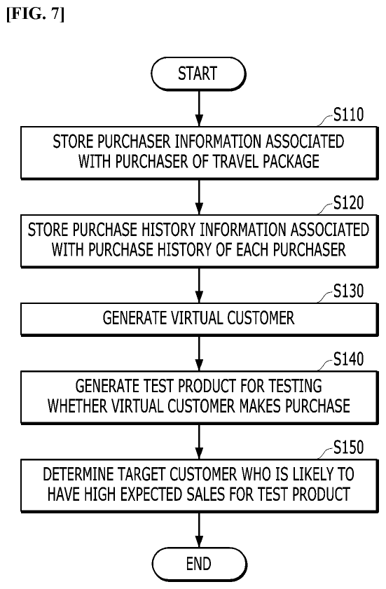

FIG. 7 is a flowchart illustrating an operation of the target customer recommendation device according to the embodiments of the present disclosure. The operations described with reference to FIG. 7 may be implemented as instructions executable by a computing device, and the instructions may be stored in a computer-readable non-transitory storage medium.

Referring to FIG. 7, the target customer recommendation device 100 may store purchaser information associated with a purchaser of a travel package (S110). According to embodiments, the purchaser information storage unit 121 may store the purchaser information 121a associated with the purchaser.

The target customer recommendation device 100 may store the purchase history information (S120). According to embodiments, the purchase history information storage unit 123 may store the purchase history information 123a associated with the purchase history of each of the purchasers.

The target customer recommendation device 100 may generate a virtual customer (S130). According to embodiments, the virtual customer generation unit 131 may determine each attribute (e.g., age, gender, and area) of the virtual customer, and generate the virtual customer having the corresponding attributes. For example, the virtual customer generation unit 131 may use the stored purchaser information 121a to generate virtual customers.

The target customer recommendation device 100 may generate a test product (S140). According to embodiments, the test product generation unit 133 may generate a test product for testing whether virtual customers may a purchase. For example, the test product generation unit 133 may determine the attributes (e.g., price, travel area, travel period, the number of travelers, etc.) of the test product, and generate the test product having the corresponding attributes.

The target customer recommendation device 100 may determine a target customer among virtual customers (S150). According to embodiments, the target customer determination unit 135 may determine, as a target customer, a virtual customer determined to have a high purchase probability for a test product from among the virtual customers. For example, the target customer determination unit 135 may calculate a purchase probability for each of the virtual customers to purchase the test product, and determine a virtual customer having the calculated purchase probability equal to or greater than a reference probability as the target customer.

Meanwhile, according to embodiments, the target customer determination unit 135 may use the calculated purchase probability and the sale price of the test product to calculate the expected sales of the test product for the virtual customers and determine, as a target customer, a virtual customer who is determined to have high expected sales. For example, the target customer determination unit 135 may determine, as a target customer, virtual customers having the calculated expected sales equal to or greater than the reference sales.

That is, the target customer determination unit 135 may select a target customer from among the virtual customers according to the purchase probability or expected sales. However, for convenience of description, hereinafter, it is assumed that the target customer determination unit 135 selects the target customer according to the purchase probability.

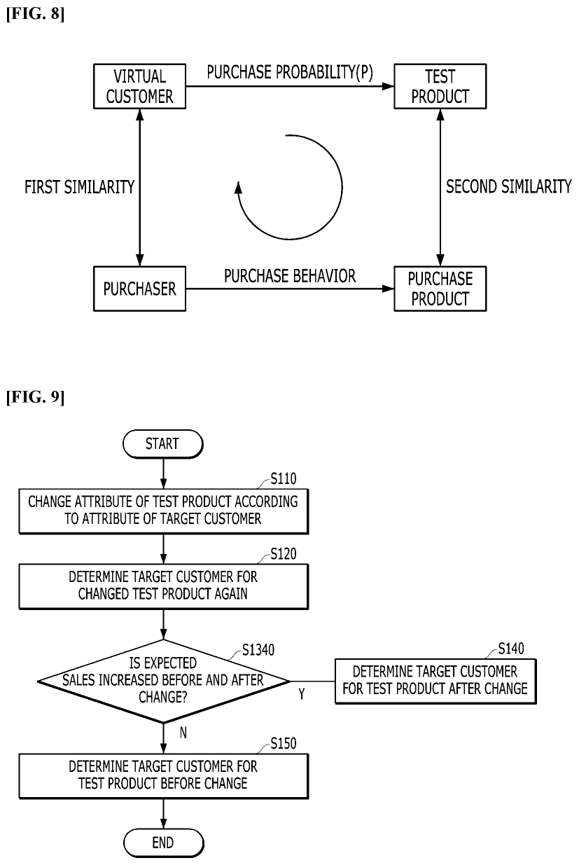

FIG. 8 is a diagram illustrating a method of calculating a purchase probability according to embodiments of the present disclosure. Referring to FIG. 8, the target customer determination unit 135 may determine a target customer by calculating a purchase probability P for a virtual customer to purchase a test product.

The target customer determination unit 135 may calculate the purchase probability P that the virtual customer will purchase the test product based on the purchaser information 121a and the purchase history information 123a. According to embodiments, the target customer determination unit 135 may calculate a first similarity between the virtual customer and the real purchaser, calculate a second similarity between the purchased product of the test product and the real purchaser, and uses the first similarity and the second similarity to calculate the purchase probability P.

Since the purchaser is a person who has actually purchased the purchased product, a virtual customer similar to the purchaser may be more likely to actually purchase the corresponding purchased product, and a virtual customer similar to the purchaser may be more likely to actually purchase a test product similar to the corresponding purchased product. According to this point of view, the target customer determination unit 135 may calculate the purchase probability P using the first similarity between the virtual customer and the real purchaser and the second similarity between the test product and the purchased product of the real purchaser.

The target customer determination unit 135 may calculate the first similarity by comparing the attributes of the purchaser and the attributes of the virtual customer. According to embodiments, as the age difference between the purchaser and the virtual customer becomes smaller and smaller, the residential area of the purchaser and the residential area of the virtual customer are close to each other, and the gender of the purchaser and the gender of the virtual customer are the same, the target customer determination unit 135 may calculate the first similarity to be higher.

The target customer determination unit 135 may calculate the second similarity by comparing the attributes of the purchased product and the attributes of the test product. According to embodiments, as the travel area of the purchased product and the travel area of the test product are close to each other, the difference between the price of the purchased product and the price of the test product decreases, the difference between the number of travelers of the purchased product and the number of travelers of the test product decreases, and the difference between the travel period of the purchased product and the travel period of the test product decreases, the target customer determination unit 135 may calculate the second similarity to be higher.

The target customer determination unit 135 may use the first similarity and the second similarity to select, as a target customer, virtual customers having a probability of purchasing a test product equal to or greater than a reference probability from among the virtual customers and store attributes (e.g., gender, age, and area) of target customers.

According to embodiments, the target customer determination unit 135 may group virtual customers into a plurality of virtual customer groups according to attributes based on a predetermined reference, and calculate a purchase probability for each virtual customer group to select, as a target customer group, a virtual customer group having a purchase probability equal to or greater than a reference probability from among the virtual customer groups. In this case, the purchase probability for the virtual customer group may be an arithmetic average of purchase probabilities for each of the virtual customers included in the virtual customer group, but is not limited thereto.

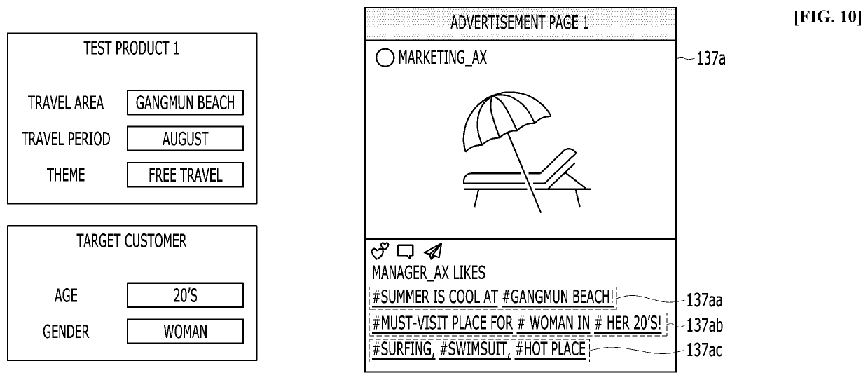

FIG. 9 is a flowchart illustrating the operation of the target customer recommendation device according to the embodiments of the present disclosure. The operations described with reference to FIG. 9 may be implemented as instructions executable by a computing device, and the instructions may be stored in a computer-readable non-transitory storage medium. The method of FIG. 9 may be performed after a target customer determination step S150 of the method described with reference to FIG. 7, but is not limited thereto.

Referring to FIG. 9, the target customer recommendation device 100 may change the attributes of the test product according to the attributes of the target customer (S210). According to embodiments, the test product generation unit 133 may change the travel area, the travel period, the travel time, the number of travelers, the travel theme, and the travel theme, which are the attributes of the test product, according to the age, the gender, and the residential area which are the attributes of the target customer.

For example, the target customer recommendation device 100 may refer to the stored purchase history information 123a to change the attributes of the test product to be similar to the attributes of the purchased product of the purchaser similar to the attributes of the determined target customer.

Alternatively, for example, when the age of the determined target customer is small, the target customer recommendation device 100 may perform a change to reduce the selling price of the test product.

Alternatively, for example, the target customer recommendation device 100 may change the travel area of the test product to an area closer to the residential area of the determined target customer.

The target customer recommendation device 100 may determine the target customer for the changed test product again (S220). According to embodiments, the target customer recommendation device 100 may recalculate the purchase probability of the virtual customers for the changed test product and determine the target customer again using the calculation result. In this case, it is preferable not to change the probability value which is a reference for determining the target customer.

The target customer recommendation device 100 may determine whether the expected sales for the test product increases before and after the change (S230). According to embodiments, the target customer recommendation device 100 may determine whether the expected sales increase by comparing the expected sales of the test product before the change with the expected sales of the test product after the change.

When the expected sales of the test product before and after the change increases (Y in S230), the target customer recommendation device 100 may determine the target customer for the test product after the change (S240). According to embodiments, the target customer recommendation device 100 may store or transmit information on a test product and a target customer corresponding to the test product after the change.

When the expected sales of the test product before and after the change decreases (N in S230), the target customer recommendation device 100 may determine the target customer for the test product before and after the change (S250). According to embodiments, the target customer recommendation device 100 may store or transmit information on a test product and a target customer corresponding to the test product before the change.

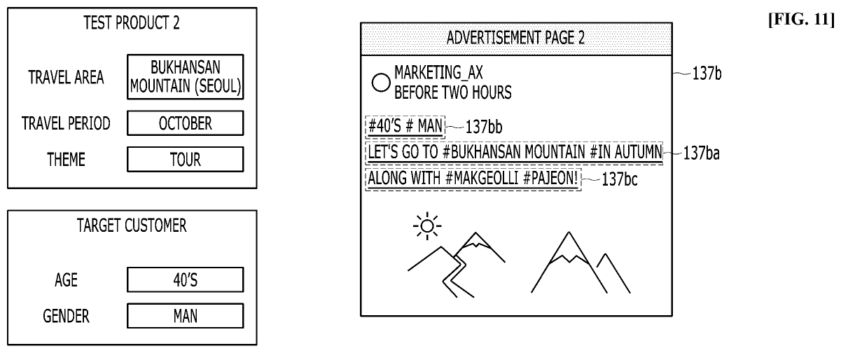

FIGS. 10 and 11 are diagrams for describing an operation of an advertisement page generation unit according to embodiments of the present disclosure. Referring to FIGS. 10 and 11, an advertisement page generation unit 137 may generate advertisement pages 137a and 137b to advertise the test product.

Meanwhile, in this specification, the generation of the advertisement pages 137a and 137b by the advertisement page generation unit 137 includes performing an operation of transmitting phrases for generating the advertisement pages 137a and 137b to an advertisement server generating the advertisement pages 137a and 137b.

The advertisement page generation unit 137 may generate product phrases 137aa and 137ba indicating the test product, customer phrases 137ab and 137bb indicating the target customer, and interest phrases 137ac and 137bc for catching a target customer's interest, thereby generating the advertisement pages 137a and 137b.

According to embodiments, the advertisement page generation unit 137 may generate the product phrases 137aa and 137ba indicating the attributes (e.g., travel period and travel location) of the test product. In this case, the advertisement page generation unit 137 may generate the product phrases 137aa and 137ba by reading phrases associated with the attributes of the test product from among idiomatic phrases. For example, the advertisement page generation unit 137 may generate the advertisement page 137a including the product phrase 137aa including “summer” associated with “August” which is a travel period of “test product 1” among the idiomatic phrases.

Meanwhile, the idiomatic phrase may be pre-stored in the target customer recommendation device 100 or searched from the web.

According to embodiments, the advertisement page generation unit 137 may generate the customer phrases 137ab and 137bb indicating the attributes (e.g., age and gender) of the target customer. For example, the advertisement page generation unit 137 may generate the customer phrases 137ab and 137bb by reading the idiomatic phrases associated with the attributes of the target customer from among the idiomatic phrases.

According to embodiments, the advertisement page generation unit 137 may generate the interest phrases 137ac and 137bc by reading phrases having a high preference of the target customer from among the idiomatic phrases according to the attributes (e.g., age and gender) of the target customer. For example, the advertisement page generation unit 137 may search for a phrase preferred by a “woman in her 20's” as a target customer, and generate the advertisement page 137a including the interest phrase 137ac including “surfing,” “swimsuit,” and “hot place” from the search result.

The advertisement page generation unit 137 may determine an advertisement channel corresponding to attributes of at least one of the target customer and the test product, and generate an advertisement page through the determined advertisement channel.

The advertisement page generation unit 137 may transmit phrases for generating an advertisement page through the determined advertisement channel. For example, the advertisement page generation unit 137 may transmit a link for generating an advertisement page to a user through the determined advertisement channel.

The advertisement page generation unit 137 may generate the advertisement page through the advertisement channel suitable for the attributes of the target customer. According to embodiments, the advertisement page generation unit 137 may store attributes of a plurality of advertisement channels, and compare the stored attributes of the advertisement channel with the attributes of the target customer, thereby determining the advertisement channel suitable for the attributes of the target customer. For example, the attributes of the advertisement channel may include a preferred age, a subject, a preferred gender, and the like.

For example, the advertisement page generation unit 137 may generate the advertisement page through the advertisement channel in which the number of users is relatively large (i.e., popular) in the age and gender of the target customer. For example, the advertisement page generation unit 137 may generate the first advertisement page 137a through a first advertisement channel popular with young women for a first test product in which “20's” and “women” are target customers. On the other hand, for the second test product whose target customer are “40's” and “man,” the second advertisement page 137b may be generated through the second advertisement channel popular with middle-aged men.

According to embodiments, the advertisement page generation unit 137 may generate the advertisement page through the advertisement channel suitable for the attributes of the test product. For example, the advertisement page generation unit 137 may generate an advertisement page through an advertisement channel having a relatively large number of pages (or contents) for the travel area of the test product.

According to embodiments of the present disclosure, it is possible to not only determine a target customer having high expected sales for the test product, but also automatically generate the advertisement page for the test product to advertise to the determined target customer. In particular, according to embodiments of the present disclosure, it is possible to automatically determine the advertisement channel suitable for the attributes of the target customer and the test product, and to generate the advertisement page through the determined advertisement channel.

According to an electronic device according to embodiments of the present disclosure, it is possible to generate a test product and determine a target customer having high expected sales for a test product.

According to an electronic device according to embodiments of the present disclosure, it is possible to automatically generate an advertisement page of a test product for advertising to the determined target customer.

The spirit of the present disclosure has been illustratively described hereinabove. It will be appreciated by those skilled in the art that various modifications and alterations may be made without departing from the essential characteristics of the present disclosure. Accordingly, exemplary embodiments disclosed in the present disclosure are not to limit the spirit of the present disclosure, but are to describe the spirit of the present disclosure. The scope of the present disclosure is not limited to these exemplary embodiments. The scope of the present disclosure should be interpreted by the following claims, and it should be interpreted that all the spirits equivalent to the following claims fall within the scope of the present disclosure.

What is claimed is:

1. An electronic device, comprising:
a memory; and
a processor configured to control the electronic device by executing instructions stored in the memory so that the electronic device determines a target customer suitable for selling a travel package,
wherein the memory stores purchaser information associated with actual purchasers who have purchased travel packages of a plurality of sellers and purchase history information associated with purchase histories of each of the purchasers, and
the processor generate virtual customers from a real purchaser by using the purchaser information, generate a test product for testing whether virtual customers make a purchase, and determine a target customer having high expected sales for the test product among the virtual customers.

2. The electronic device of claim 1, wherein the processor calculates a purchase probability for each of the virtual customers to purchase the test product, and determines the target customer based on the calculated purchase probability.

3. The electronic device of claim 2, wherein the processor groups the virtual customers into a plurality of virtual customer groups, calculates the purchase probability for each virtual customer group, and determines at least one of the plurality of virtual customer groups as the target customer based on the calculated purchase probability.

4. The electronic device of claim 2, wherein the processor calculates a first similarity between the virtual customer and the real purchaser by comparing attributes of the virtual customer and the real purchaser,
calculates a second similarity between the test product and the purchased product by comparing attributes of the test product and a product purchased by the real purchaser, and
calculates the purchase probability based on the first similarity and the second similarity.

5. The electronic device of claim 4, wherein the processor calculates the first similarity based on at least one of a difference between an age of the virtual customer and an age of the purchaser, a distance between a residential area of the virtual customer and a residential area of the purchaser, and whether a gender of the virtual customer matches a gender of the purchaser.

6. The electronic device of claim 4, wherein the processor calculates the second similarity based on at least one of a distance between a travel area of the test product and a travel area of the purchased product, a difference between a price of the test product and a price of the purchased product, a difference between the number of travelers of the test product and the number of travelers of the purchased product, and a difference between a travel period of the test product and a travel period of the purchased product.

7. The electronic device of claim 1, wherein the processor changes an attribute of the test product according to an attribute of the determined target customer to generate a new test product, and determines the target customer for the newly generated test product again.

8. The electronic device of claim 1, wherein the processor generates an advertisement page for advertising the test product to the target customer.

9. The electronic device of claim 8, wherein the processor reads a product phrase associated with the attribute of the test product,
reads a customer phrase associated with the attribute of the target customer,
reads an interest phrase in which a preference of the target customer is greater than a reference, and
generates the advertisement page including the product phrase, the customer phrase, and the interest phrase.

10. The electronic device of claim 8, wherein the processor determines an advertisement channel suitable for the target customer by comparing the attributes of a plurality of advertisement channels with the attributes of the determined target customer, and
generates the advertisement page through the determined advertisement channel.

11. A method for determining target customer suitable for travel package performed by the electronic device, comprising:
generating virtual customers from a real purchaser by using the purchaser information, the purchaser information associated with actual purchasers who have purchased travel packages of a plurality of sellers and purchase history information associated with purchase histories of each of the purchasers,
generating a test product for testing whether virtual customers make a purchase, and
determining the target customer having high expected sales for the test product among the virtual customers.

12. The method of claim 11, further comprising:
calculating a purchase probability for each of the virtual customers to purchase the test product, and
determining the target customer based on the calculated purchase probability.

13. The method of claim 12, further comprising:
grouping the virtual customers into a plurality of virtual customer groups,
calculating the purchase probability for each virtual customer group, and
determining at least one of the plurality of virtual customer groups as the target customer based on the calculated purchase probability.

14. The method of claim 12, further comprising:
calculating a first similarity between the virtual customer and the real purchaser by comparing attributes of the virtual customer and the real purchaser,
calculating a second similarity between the test product and the purchased product by comparing attributes of the test product and a product purchased by the real purchaser, and
calculating the purchase probability based on the first similarity and the second similarity.

15. The method of claim 14, further comprising:
calculating the first similarity based on at least one of a difference between an age of the virtual customer and an age of the purchaser, a distance between a residential area of the virtual customer and a residential area of the purchaser, and whether a gender of the virtual customer matches a gender of the purchaser.

16. The method of claim 14, further comprising:
calculating the second similarity based on at least one of a distance between a travel area of the test product and a travel area of the purchased product, a difference between a price of the test product and a price of the purchased product, a difference between the number of travelers of the test product and the number of travelers of the purchased product, and a difference between a travel period of the test product and a travel period of the purchased product.

17. The method of claim 11, further comprising:
changing an attribute of the test product according to an attribute of the determined target customer to generate a new test product, and
determining the target customer for the newly generated test product again.

18. The method of claim 1, further comprising:
generating an advertisement page for advertising the test product to the target customer.

19. The method of claim 18,
reading a product phrase associated with the attribute of the test product,
reading a customer phrase associated with the attribute of the target customer,
reading an interest phrase in which a preference of the target customer is greater than a reference, and
generating the advertisement page including the product phrase, the customer phrase, and the interest phrase.

20. The method of claim 18, further comprising:
determining an advertisement channel suitable for the target customer by comparing the attributes of a plurality of advertisement channels with the attributes of the determined target customer, and
generating the advertisement page through the determined advertisement channel.
